(19) United States
(12) Patent Application Publication
(10) Pub. No.: US 2016/0004743 A1
(43) Pub. Date: Jan. 7, 2016

(54) METHODS AND SYSTEMS FOR DATA CLEANING

(71) Applicant: QATAR FOUNDATION, Doha (QA)

(72) Inventors: Nan Tang, Doha (QA); Jiannan Wang, Doha (QA)

(21) Appl. No.: 14/765,960

(22) PCT Filed: Feb. 7, 2013
(86) PCT No.: PCT/EP2013/052476

§ 371 Date: Aug. 5, 2015

(51) Int. Cl. G06F 17/30

(52) U.S. Cl. CPC G06F 17/30371

(57) ABSTRACT

A method for cleaning data stored in a database which utilises a data fixing rule. The data fixing rule comprises a set of attribute values that capture an error in a plurality of semantically related attribute values. The data fixing rule also comprises a deterministic correction which is operable to replace one of the set of attribute values with a correct attribute value to correct the error. The method comprises applying the data fixing rule to the database to detect if the set of attribute values that captures the error is stored in the database and, if the set of attribute values is detected, the method applies the deterministic correction to correct the error in the attribute values.

The present invention relates to methods and systems for data cleaning and more particularly relates to methods and systems for repairing errors in attribute values in a database.

There are numerous known methods and systems for cleaning data in a database. The term “cleaning” is used herein to mean correcting or repairing errors in values or attribute values which are stored as information in a database.

The following examples illustrate the drawbacks of the state-of-the-art work in the area of data cleaning.

Consider a database D of travel records. The database is specified by the following schema:

travel (name, country, capital, city, conf)

Here a travel tuple specifies a person, identified by name, has travelled to conference (conf), held at the city of the country and its capital. Example instances of travel are shown in Table 1 below.

TABLE 1
Database D: an instance of schema travel

| | Name | Country | Capital | City | Conf |
|---|---|---|---|---|---|
| r1 | G. Beskales | China | Beijing | Beijing | SIGMOD |
| r2 | I. Ilyas | China | Shanghai | Hong | VLDB |
| | | | | Kong | |
| r3 | P. Pappotti | China | Tokyo | Tokyo | ICDE |
| r4 | N. Tang | Canada | Toronto | Toronto | VLDB |

The following four techniques may be used to detect and repair errors in Table 1.

### (1) Integrity Constraints

A functional dependency (FD) is used to specify the consistency of travel data D as:

φ1: travel([country]→[capital])

where φ1 asserts that country uniquely determines capital.

The FD φ1 detects that in Table 1, the two tuples (r1,r2) violate φ1, since they have the same country values but different capital values, so do (r1,r3) and (r2,r3). However, φ1 does not tell us which attributes are wrong and what values they should be changed to.

Other constraints, such as conditional functional dependencies (CFDs) or denial constraints may also be introduced to detect various errors. However, these other constraints are also not able to repair data.

Using such integrity constraints, existing heuristic based approaches may choose any of the three values, Beijing, Shanghai, or Tokyo to update r1[capital]-r3[capital].

### (2) User Guided Repairs

It is known to clean data using repairs which are guided by users. Assuming that the three violations among tuples r1-r3 have been detected as in (1), a typical user guided repair raises a question to users such as: Which is the capital of China: Beijing, Shanghai, or Tokyo?

One can assume that the users pick Beijing as the capital of China. This corrects the erroneous value r2[capital], from Shanghai to Beijing. However, the error in r3 should be r3[country], which should be Japan instead of China. The response from the users is therefore not helpful to fix the error in r3. Worse still, the change prompted by the uses will introduce a new error as it changes r3[capital] from Tokyo to Beijing.

### (3) Editing Rules

Editing rules can be used to capture and repair errors. Master data stores correct information about countries and their capitals. The schema of the master data is:

cap (country, capital).

A master relationship between the attributes in Table 1 is shown in Table 2.

TABLE 2
Database Dm: an instance of schema cap

| | Country | Capital |
|---|---|---|
| s1 | China | Beijing |
| s2 | Canada | Ottawa |
| s3 | Japan | Tokyo |

A conventional editing rule ψ1 is defined on two relations (travel, cap) as:

ψ1: ((country, country)→(capital, capital), tp1[country]=( ))

The editing rule ψ1 states that: for a tuple r in table travel, if r[country] is correct and it matches a tuple s in relation cap, r[capital] can be updated using the value s[capital] drawn from the master data cap.

For instance, to repair r2 in Table 1, r2 is initially matched to s1 in the master data. Users are then asked to verify that r2[country] is indeed China, and the rule then updates r2[capital] to Beijing. Similarly, r4[capital] can be corrected to be Ottawa by using ψ1 and s2 in Dm, if users verify that r4[country] is Canada. The case for r3 is more complicated since r3[country] is Japan and not China. Therefore, more effort is required to correct r3.

### (4) Extract Transform Load (ETL) Rules

A typical task in an ETL rule is a lookup operation, assuming the presence of a dictionary (e.g., the master data Dm in Table 2). For each tuple r in D in Table 1, assuming attribute country is correct, the rule will lookup table Dm and update the attribute values of capital in D. In this case, the rule corrects r2[capital] (resp. r4[capital]) to Beijing (resp. Ottawa). However, the rule then introduces a new error also messes by changing the value of r3[capital] from Tokyo to Beijing, similar to the case (2) above.

The above four repair examples illustrate the following problems with such conventional techniques:
(a) Heuristic methods for repairing data based on integrity constraints do not guarantee to find correct fixes. Worse still, they may introduce new errors when trying to repair the data, as in case (1) above.
(b) It is reasonable to assume that users may provide correct answers to verify data. However, new errors can still be introduced by using user provided answers, such as in case (2) above.
(c) Master data (or a dictionary) that is guaranteed correct is a feasible repair option. However, it is prohibitively expensive to involve users for each data tuple correction (case (3)), or to ensure that certain columns are correct (case (4)).

There is therefore a need for improved data cleaning rules which seek to overcome the above problems.

According to one aspect of the present invention, there is provided a method for cleaning data stored in a database, the method comprising providing a data fixing rule, the data fixing rule comprising a set of attribute values that capture an error in a plurality of semantically related attribute values, and a deterministic correction which is operable to replace one of the set of attribute values with a correct attribute value to correct the error, applying the data fixing rule to the database to detect if the set of attribute values that captures the error is stored in the database and, if the set of attribute values is detected, applying the deterministic correction to correct the error in the attribute values.

Preferably the data fixing rule is defined for a relationship R in the form (((X, tp[X]),(B,−Tp[B]))→+tp[B]), where X is a set of attribute values in attr(R) and B is an attribute value in attr(R) \X tp[X] is a pattern with attribute values in X and, for each A∈X, tp[A] is a constant in dom(A)−Tp[B] is a finite set of constant values in dom(B); and +Ftp[B] is a constant value in dom(B) \−Tp[B], wherein +tp[B] of B indicates the correction to an error in attribute value B.

Conveniently the method detects a set of attribute values in the database that captures the error if a tuple t of attribute values of R matches a rule φ: (((X, tp[X]),(B,−Tp[B]))→+tp[B]), if (i) t[X]=Tp[X], and (ii) t[B]∈−Tp[B].

Advantageously the data fixing rule comprises at least one similarity operator which is operable to detect variants of attribute values.

Preferably the data fixing rule is operable to use a wildcard attribute value in the set of attribute values.

Conveniently the data fixing rule is operable to detect the negation of an attribute value.

Advantageously the method comprises providing a plurality of data fixing rules and applying at least one of the plurality of data fixing rules to the database.

According to another aspect of the present invention, there is provided a system for cleaning data stored in a database, the system being operable to perform the method of any one of claims 1 to 7 hereinafter.

According to a further aspect of the present invention, there is provided a computer readable medium storing instructions which, when executed, are operable to perform the method of any one of claims 1 to 7 hereinafter.

According to a still further aspect of the present invention, there is provided a data fixing rule comprising a set of attribute values that capture an error in a plurality of semantically related attribute values, and a deterministic correction which is operable to replace one of the set of attribute values with a correct attribute value to correct the error.

An embodiment of the present invention utilises a set of data cleaning rules that not only detect errors from semantically related attribute values, but also automatically correct these errors without necessarily using any heuristics or interacting with users.

A data fixing rule of an embodiment of the invention contains an evidence pattern, a fact and a set of negative patterns. When a given tuple matches both the evidence pattern and the negative pattern of the rule, it is identified as an error, and the fixing rule will use the fact to correct the tuple.

This is possible by combining an evidence pattern, negative patterns and a fact into a single data fixing rule. The evidence pattern is a set of values with each value for one attribute. The negative patterns are a set of attribute values that capture an error on one attribute from semantically related values. The fact specifies a deterministic way to correct the error.

Consider a tuple t in relation travel, an example fixing rule φ1 is: for t, if its country is China and its capital is Shanghai or Hong Kong, t[capital] should be updated to Beijing.

This rule makes corrections to attribute t[capital], by taking the value from φ1, if t is identified by φ1 that current value t[capital] is wrong.

Another fixing rule φ2 is: for t in travel, if its country is Canada and its capital is Toronto, t[capital] should be updated to Ottawa.

Consider the database in Table 1.
Fixing rule φ1 detects that r2[capital] is wrong, since r2[country] is China, but r2[capital] is Shanghai. Rule φ1 will then update t2[capital] to Beijing.
Fixing rule φ2 detects that r4[capital] is wrong, and then corrects it to Ottawa.

After applying φ1-φ2, two errors (r2[capital], r4[capital]) have been fixed, while one remains (r3[capital]).

The above example indicates that:

(a) Fixing rules make dependable fixes, which do not introduce errors as in the heuristics rule in case (1) described above.

(b) Fixing rules do not claim to correct all errors, e.g., the combination (China, Tokyo). This combination may even be difficult for users to correct.

(c) Fixing rules neither require master data (3,4), or assume some attributes to be correct (2,4), nor interact with the users (2,3).

### Fixing Rules—Syntax

A fixing rule φ defined on a relation R is of the form (((X, tp[X]),(B,−Tp[B]))→+tp[B]) where:

1. X is a set of attributes in attr(R), and B is an attribute in attr(R) \X. Here, the symbol ‘\’ represent set minus;

2. tp[X] is a set of attribute values in X, referred to as the evidence pattern. For each A∈X, tp[A] is a constant in dom(A);

3. −Tp[B] is a finite set of constant values in dom(B), referred to as the negative patterns of B; and

4. +tp[B] is a constant value in dom(B) \−Tp[B], referred to as the fact of B.

Intuitively, the evidence pattern tp[X] of X, together with the negative patterns −Tp[B] of B impose the condition to determine whether a tuple contains an error on attribute B, and the fact +tp[B] of B indicates how to correct the error on attribute B.

Note that the above condition 4 enforces that the correct value (i.e., the fact) is different from any known wrong values (i.e., negative patterns).

A tuple t of R matches a rule φ: (((X, tp[X]),(B,−Tp[B]))→+tp[B]), if
(i) t[X]=Tp[X], and
(ii) t[B]∈−Tp[B].

Consider the fixing rules described in the above example. The rules can be formally expressed as follows:

φ1: ((([country],[China]),(capital,{Shanghai, Hong Kong}))→Beijing)

φ2: ((([country],[Canada]),(capital,{Toronto}))→Ottawa)

In both φ1 and φ2, X consists of country, B is capital. The pattern of φ1 states that, for a tuple, if its country is China and its capital value is in the set {Shanghai, Hong Kong}, its capital value should be updated to Beijing.

Consider the database D in Table 1. Tuple r1 does not match rule φ1, since r1[country]=China, but r1[capital]∈{Shanghai, Hong Kong}. On the contrary, tuple r2 matches rule φ1, since 2[country]=China, and r2[capital]∈{Shanghai, Hong Kong}. Similarly, we have r3 matches φ1 and r4 matches φ2.

### Fixing Rules—Semantics

A fixing rule φ applies to a tuple t, denoted by t→φt′, if
(1) t matches φ, and
(2) t′ is obtained by the update t[B]:=+tp[B].

That is, if t[X] agrees with tp[X] and t[B] appears in the set −Tp[B], then +tp[B] is assigned to t[B]. Intuitively, if t[X] matches tp[X] and t[B] matches some value in −Tp[B], it is dependable to judge that t[B] is erroneous and hence, it is reliable to update t[B] to +tp[B]. This yields an updated tuple t′ with t′[B]=+tp[B] and t′[R \ {B}]=t[R \ {B}].

Fixing rules are quite different from integrity constraints, such as CFDs. Integrity constraints have static semantics: they only detect data violations for given constraints, but they do not tell how to change resolve them. In contrast, a fixing rule φ specifies an action: applying φ to a tuple t yields an updated t′.

Editing rules have a dynamic semantics. In contrast to them, fixing rules (a) neither require the presence of master data or confidence values placed on attributes, and (b) nor interact with the users.

Fixing rules are different from Extract Transform Load (ETL) rules which refer to a process in database usage and especially in data warehousing that involves: (a) Extracting data from outside sources, (b) Transforming it to fit operational needs (which can include quality levels), and (c) Loading it into the end target e.g., database. Fixing rules, on the other hand, focus on detect errors from attribute values that depend on each other. Fixing rules can capture errors that ETL rules fail to detect.

In one embodiment, ETL rules are used to extract data from a source and fixing rules are then used to clean the extracted data.

Heuristic solutions, which use integrity constraints, may be used in addition to fixing rules. That is, fixing rules can be used initially to find dependable fixes and then heuristic solutions can be used to compute a consistent database.

Editing rules and fixing rules should be used for different targets. Editing rules are used for critical data, which needs heavy involvement of experts to ensure, for each tuple, that the attributes are correct. Fixing rules, on the other hand, can be used for more general data cleaning applications that cannot afford to involve users to clean each tuple.

### Fixing Rule Algorithm

Recall that when applying a fixing rule φ to a tuple t, t[B] is updated with the value +tp[B]. To ensure that the change makes sense, the values that have been validated to be correct should remain unchanged in the following process. That is, after applying φ to t, the set X U {B} of attributes should be marked as correct for tuple t.

The following algorithm is based on the above observation.
Algorithm. ApplyFixingRules
input: a set Σ of fixing rules, and a tuple t
output: a repaired tuple t′
(let V denote the set of attributes that are validated to be correct, initially empty)
step1: find a rule φ in Σ that can be applied to t;
step2: if such rule φ exists, update t to t′ using φ, extend V to include
validated attributes w.r.t. φ, and go back to step (1);
step3: if no such rule φ exists, return t′.

Note that the above algorithm will terminate, since the number of validated attributes in V will increase monotonically, up to the total number of attributes in relation R.

### Data Fixing Rule Extensions

(1) Similarity Operators

Domain-specific similarity functions are used in one embodiment to replace all equality comparisons. This makes it easier to capture typographical errors (e.g., Ottawo) and different spelling variants (e.g., Hong Kong and Peking), as opposed to including them as negative patterns in fixing rules.

(2) Wildcard

The wildcard ‘*’ may be allowed in the pattern. For instance, a fixing rule can be extended as:

φ′:((([country],[China]),(capital, *))→Beijing)

Intuitively, the rule φ′ assumes that for a tuple t, t[country] is correct, if t[country] is China. No matter what value that t[capital] takes, φ′ will update t[capital] to Beijing. This is equivalent to the ETL lookup operations.

(3) Negation

In one embodiment, negations are added to the match conditions. Intuitively, a tuple can match a rule only when certain conditions are not satisfied. For instance, certain fixing rules can be applied when the country is not China.

The clear advantage of fixing rules, compared with the prior art, is that they can automatically detect errors and derive dependable repairs without interacting with the users, and without the assumption that some values have been validated to be correct. In contrast, all conventional techniques either (1) use heuristic approaches to compute a consistent database by making minimum number of changes, or (2) to consult the users, or use master data, or assume some attributes are correct, in order to derive dependable fixes.

Data fixing rules can be employed easily in many products to detect errors and perform dependable data repairing. Data fixing rules can be used to carry out more dependable data repairs than tools that are currently widely employed in industry (i.e., ETL tools) for name standardization, address check, etc.

Data has become an important asset in today's economy. Extracting values from large amounts of data to provide services and to guide decision making processes has become a central task in all data management stacks. The quality of data becomes one of the differentiating factors among businesses and the first line of defence in producing value from raw input data. As data is born digitally and is fed directly into stacks of information extraction, data integration, and transformation tasks, ensuring the quality of the data with respect to business and integrity constraints have become more important than ever.

When used in this specification and claims, the terms “comprises” and “comprising” and variations thereof mean that the specified features, steps or integers are included. The terms are not to be interpreted to exclude the presence of other features, steps or components.

1. A method for cleaning data stored in a database, the method comprising:
providing a data fixing rule to capture an error, the data fixing rule comprising:
a first set of attributes and respective attribute values;
a second set of attributes and respective attribute values, wherein the second set of attribute values are erroneous values; and
a correct value;
applying the data fixing rule to the database to capture the error, wherein the error is captured when the first set of attributes and attribute values, and the second set of attributes and at least one of the erroneous values of the second set of attribute values match a record in the database; and
replacing the at least one erroneous value in the record with the correct value.

2. The method according to claim 1, wherein the data fixing rule is defined for a relationship R in the form (((X, tp[X]),(B,−Tp[B]))→+tp[B]), where:
X is a set of attributes in attr(R) and B is an attribute in attr(R) \ X;
tp[X] is a pattern with attribute values in X and, for each A∈X, tp[A] is a constant in dom(A);
−Tp[B] is a finite set of constant values in dom(B); and
+tp[B] is a constant value in dom(B) \−Tp[B], wherein +tp[B] of B indicates the correction to an erroneous value in −Tp[B].

3. The method according to claim 1, wherein the method detects a set of attribute values in the database that captures the error if a tuple t of attribute values of R matches a rule φ: (((X, tp[X]),(B,−Tp[B]))→+tp[B]), if
(i) t[X]=Tp[X], and
(ii) t[B]∈−Tp[B].

4. The method according to claim 1, wherein the data fixing rule comprises at least one similarity operator which is operable to detect variants of the first set and the second set of attribute values in the database.

5. The method according to claim 1, wherein the data fixing rule is operable to use a wildcard attribute value in the first set and the second set of attribute values.

6. The method according to claim 1, wherein the data fixing rule is operable to detect the negation of an attribute value.

7. The method according to claim 1, wherein the method further comprises providing a plurality of data fixing rules and applying at least one of the plurality of data fixing rules to the database.

8. A system for cleaning data stored in a database, the system being operable to perform the method of claim 1.

9. A computer readable medium storing instructions which, when executed, are operable to perform the method of claim 1.

10. The method according to claim 1, wherein the data fixing rule is defined for a relationship R in the form (((X, tp[X]),(B,−Tp[B]))→+tp[B]), where:
X is a set of attributes in attr(R) and B is an attribute in attr(R) \ X;
tp[X] is a pattern with attribute values in X and, for each A∈X, tp[A] is a constant in dom(A);
−Tp[B] is a finite set of constant values in dom(B); and
+tp[B] is a constant value in dom(B) \−Tp[B], wherein +tp[B] of B indicates the correction to an erroneous value in −Tp[B],
wherein the method detects a set of attribute values in the database that captures the error if a tuple t of attribute values of R matches a rule φ: (((X, tp[X]),(B,−Tp[B]))→+tp[B]), if
(i) t[X] =Tp[X], and
(ii) t[B]∈−Tp[B].
